(19) United States
(12) Patent Application Publication
(10) Pub. No.: US 2007/0283878 A1
(43) Pub. Date: Dec. 13, 2007

(54) Magnetic dosing display

(76) Inventor: Peter G. Will, Maple Grove, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/451,819

(22) Filed: Jun. 13, 2006

(51) Int. Cl. G09F 9/00

(52) U.S. Cl. 116/308

(57) ABSTRACT

A medication dispensing tracking and scheduling system can include a magnetic tracking assembly having a time display portion, a patient identification portion and an adjustable tracking portion. The magnetic tracking assembly can be prominently displayed on suitable metal surfaces such as, for example, a kitchen appliance, so as to be easily visible and to avoid misplacing the various portions of the magnetic tracking assembly. The time display portion can include a time scale corresponding to the hours of the day. The instruction portion can include dosing and dispensing information for the medication. The adjustable tracking portion can allow for adjustable tracking of prior and upcoming times for dispensing medication.

### FIELD OF THE INVENTION

The present application is directed toward communication tools for communicating patient dosing information. More specifically, the present application is directed to a magnetic dosing display including easily adjustable dosing markers and a patient identifier so as to provide safe medication dispensing.

### BACKGROUND OF THE INVENTION

Once an individual has been diagnosed with a malady requiring consumption of medication, it becomes important not only that the medication be taken but also that the medication is taken in proper amounts and at designated time durations between doses. With some medications, failure to take medication in the proper amounts, either too much or not enough, or outside designated time durations, too frequently or not frequent enough, can limit the effectiveness of the medication and may lead to additional complications for the patient.

In a hospital, clinical or other controlled environment, a variety of mechanisms can be utilized to ensure medication is dispensed properly. Often this involves routine charting and observation by medical professionals who have experience both with the various maladies suffered by individuals as well as the variety of medications used and/or unpractical outside of such controlled settings as average individuals generally do not possess the experience nor the dedicated time necessary to properly implement such procedures.

In a typical situation, patients and caregivers such as, for example, parents, spouses, family members and other caregivers, must dispense medication on their own initiative when either themselves or someone else requires medication. Frequently, parents must dispense medication to their children for a week or more following a trip to the doctor, urgent care facility or emergency room. With children especially, it is important that proper amounts of medication are dispensed at the proper time durations. Proper dispensing of the medication can prove difficult in that the parents are generally responsible for remembering what amounts are to be dispensed, when they are to be dispensed and to what child, if there are more than one, the medication is intended for. This can be further complicated when other individuals are involved with caring for the child such as, for example, daycare providers and babysitters. In the case of daycare providers, keeping track of proper medication dispensing can prove especially difficult in that oftentimes, multiple children may require medication such that great care must be taken that the proper children received the correct amounts of medication and the right time.

While the use of scheduling and documentation can help to insure the proper dispensing of medication outside a controlled setting, oftentimes the burdens and difficulties of everyday situations can make such control difficult. As such, it would be advantageous to have a medication dispensing tracking and scheduling system that is both simple and convenient to use.

### SUMMARY OF THE INVENTION

A medication dispensing tracking and scheduling system of the present disclosure can comprise a magnetic tracking assembly having a time display portion, a patient identification portion and an adjustable tracking portion. The magnetic tracking assembly can be prominently displayed on suitable metal surfaces such as, for example, a kitchen appliance, so as to be easily visible and to avoid misplacing the various portions of the magnetic tracking assembly. The time display portion can comprise a display of numbers corresponding to the hours of the day or may resemble a clock or watch display and can further include an indication for am or pm reference. The patient identification form can comprise space for placing a patient's name and can also include a frame or defined opening for retaining a photograph or other patient specific reference. The adjustable tracking portion can comprise a plurality of magnetic pieces that can be positioned with respect to the time display portion for designating the time the most recent dose was dispensed and when the next dose is due.

In one aspect, the present disclosure is directed to a magnetic assembly for tracking and scheduling the dispensing of medication. The magnetic assembly can comprise a primary display portion and one or more adjustable markers. The primary display portion can comprise a printed time display and a patient identity display. The printed time display can comprise a listing of numbers corresponding to the hours of the day or may be arranged in a clock or watch-like arrangement and can further include an am or pm reference. The patient identity display can include a place for writing or printing the patient's name as well as a frame portion for receiving and retaining a photograph or other symbol identifying the patient. The primary display portion can further comprise a calendar or day tracking mechanism for monitoring the number of days that the patient has been taking the medication. The one or more adjustable markers can comprise magnetic pointers intended to interface with the printed time display to indicate when the next medication is to be dispensed and/or when the last medication was dispensed. In one representative embodiment, the primary display portion and the one or more adjustable markers are die cut from a single sheet of magnetic material. In some embodiments, the magnetic assembly can be specific to a particular medication so as to include specific dosing instructions, either on the primary display portion or on a magnetic dosing card that can be die cut as part of the frame portion. The magnetic assembly can further comprise advertising for a clinic, pharmacy or medication, safety information, emergency numbers and the like.

In another aspect, the present disclosure is directed to a method for tracking and scheduling medication dosing for an individual. A magnetic tracking assembly can be provided including a display portion and a tracking portion. The display portion can be displayed on a suitable metal surface such as, for example, a kitchen appliance such that the tracking and scheduling information is readily visible without risk of loss. The tracking portion can include one or more magnetic markers that are positioned with respect to the display portion for indicating when the latest medication was dispensed and/or when the next medication should be dispensed. The method can further include identifying the patient by providing a name in a designated area on the display portion as well as affixing a photograph or other patient specific symbol to a frame portion of the display portion. The method can further include tracking the number of days a patient has been taking the medication through the use of calendar or day display on the display portion of the magnetic tracking assembly.

In another aspect, the present disclosure is directed to a medication system comprising a therapeutic medication and a magnetic medication tracking assembly for displaying dosing information for the therapeutic medication. The magnetic medication tracking assembly can be specific to the therapeutic medication and can include features such as, for example, colors, shapes, logos and the like that visually indicate the compatibility and cooperative nature of the therapeutic medication and the magnetic medication tracking assembly. The magnetic medication tracking assembly can comprise a display portion and one or marking members, wherein the marking members are positionable with respect to the display portion so as to indicate when a most recent dose of medication was dispensed and/or when the next dose of medication is due.

The above summary of the various representative embodiments of the invention is not intended to describe each illustrated embodiment or every implementation of the invention. Rather, the embodiments are chosen and described so that others skilled in the art may appreciate and understand the principles and practices of the invention. The figures in the detailed description that follows more particularly exemplify these embodiments.

### BRIEF DESCRIPTION OF THE FIGURES

These as well as other objects and advantages of this invention, will be more completely understood and appreciated by referring to the following more detailed description of the presently preferred exemplary embodiments of the invention in conjunction with the accompanying drawings of which:

FIG. 1 is a front view of an embodiment of a medication dispensing tracking system of the present disclosure prior to use.

FIG. 2 is a side view of an embodiment of a magnetic sheet used to form the medication dispensing tacking system of FIG. 1.

FIG. 3 is a front view of an embodiment of a display portion and tracking portions of a medication dispensing tracking system of the present disclosure during use.

FIG. 4 is a perspective, partially hidden view of an embodiment of a medication system of the present disclosure.

FIG. 5 is a front view of the medication dispensing tracking system of FIG. 1 being use to tracking medication dispensing.

FIG. 6 is a front view of an embodiment of a medication dispensing tracking system of the present disclosure prior to use.

FIG. 7 is a front view of an embodiment of a medication dispensing tracking system of the present disclosure prior to use.

FIG. 8 is a front view of an embodiment of a medication dispensing tracking system of the present disclosure prior to use.

FIG. 9 is a front view of an embodiment of a medication dispensing tracking system of the present disclosure prior to use.

### DETAILED DESCRIPTION OF THE FIGURES

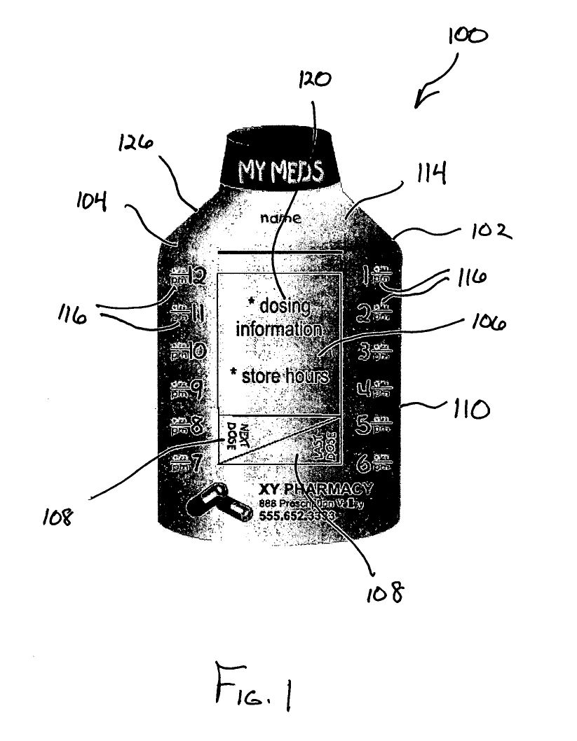

As illustrated in FIG. 1, a representative embodiment of a medication tracking system 100 can comprise a magnetic sheet 102 cut or stamped to form a display portion 104, an instruction portion 106 and one or more tracking portions 108. In one presently preferred embodiment, the instruction portion 106 and tracking portion 108 are defined with perforations such that the display portion 104, instruction portion 106 and tracking portion 108 form a connected integral pre-tracking assembly 110.

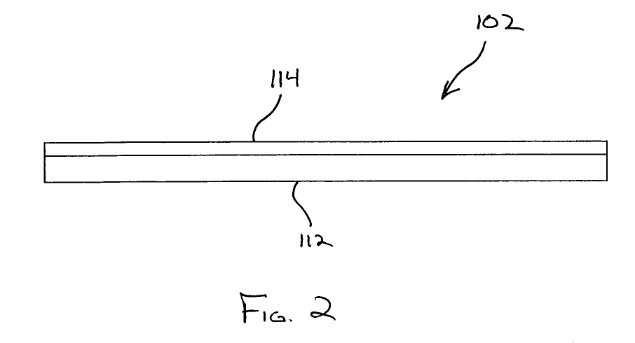

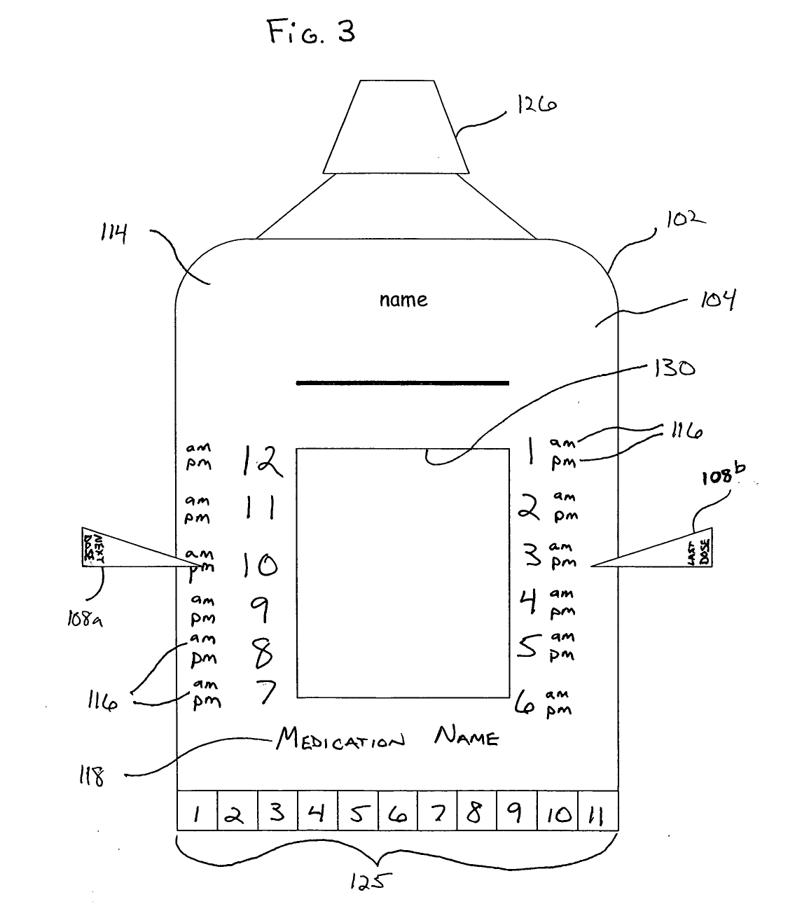

As illustrated in FIG. 2, magnetic sheet 102 generally comprises a rear magnetic layer 112 and a front display layer 114. Front display layer 114 can comprise a suitable material for displaying a variety of printed indicia such as, for example, a time scale 116, a medication name 118, medication dosage instructions 120 and dose indicators 122. In addition, front display layer 114 can preferably accommodate handwritten information such as, for example, a patients name 124 that specifically identifies who the medication tracking system 100 is displaying dispensing information for. This can be especially advantageous when two or more individuals such as, for example, siblings are each taking some form of medication. As illustrated in FIG. 3, the front display layer 114 can comprise a calendar display 125 allowing for a caregiver to track the number of days the patient has taken medication or can comprise a portion of front display layer 114 wherein the number of days can be handwritten or crossed off from a calendar.

Referring to FIGS. 1, 3 and 5, display portion 104 can be formed from magnetic sheet 102 so as to have an exterior shape 126. Exterior shape 126 can be selected from a variety of suitable forms such as, for example, a medication bottle, a logo or other desirable symbols. In some embodiments, exterior shape 126 can be selected so as to resemble the shape of a container holding the medication to be dispensed. In addition, front display layer 114 can include a color selected to resemble the color of the medication being dispensed such that the combination of the exterior shape 126 and the color of front display layer 114 cooperatively assist a caregiver with tracking and dispensing medication, especially when the caregiver is responsible for dispensing multiple medications or assisting two or more individuals. In addition to providing tracking and dispensing information to a caregiver, the appearance of front display layer 114 and exterior shape 126 can be selected as a promotional/advertising tool for a pharmacy, a pharmaceutical company or the specific medicinal product being dispensed.

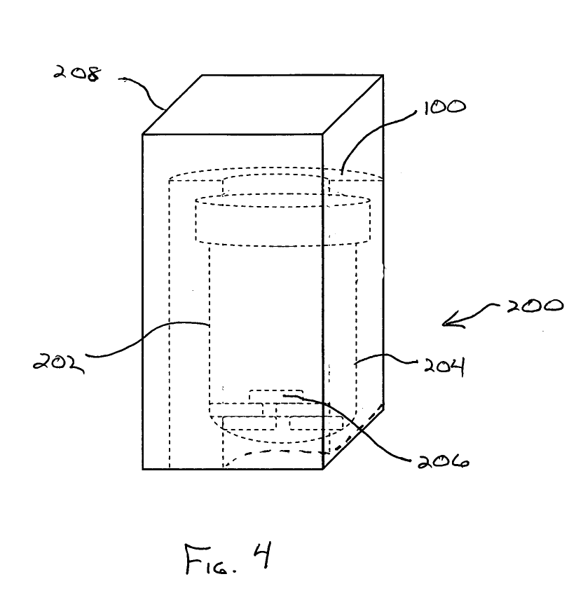

As illustrated in FIG. 4, a medication system 200 can comprise a containerized medication 202 and medication tracking system 100. Containerized medication 202 generally comprises a container 204 and a medication 206 wherein the medication 206 is typically supplied in either a liquid or solid form such as, for example, pills, tablets, capsules and gel-based forms, and the design of container 204 is selected based upon a suitability for the type of medication. Containerized medication 202 can comprise both over-the-counter products such as, for example, pain relievers, cold and flu remedies, allergy medications, and prescription drugs. With high volume over-the-counter products, it may be especially advantageous to package the medication system 200 within a box 208 or similar style packaging wherein the medication tracking system 100, and more especially, display portion 104 includes specific information tailored to the medication 206 such as, for example, the medication name, logo, trademarks, manufacturer information and any emergency instructions. In addition, product specific dosing instructions can be preprinted on instruction portion 106. With prescription medication, a pharmacist can attach or otherwise include the appropriate mediation tracking system 100 with the containerized medication 202 as a prescription is filled. Depending upon the popularity and volume of the individual prescription drugs, the pharmacy can have a stocky supply of pre-printed mediation tracking systems 100 corresponding to specific medications or alternatively, the pharmacist can attach, print or write specific instructions on blank sheet 102 that correspond to the medication 206.

In use, the medication tracking system 100 allows a caregiver to continually update and monitor medication dosing so as to promote safe dispensing of the medication 206 and avoid both over dispensation and under dispensation of the medication 206. Generally, a user separates the instruction portion 106 and the one or more tracking portions 108 from the display portion 104 as illustrated in FIG. 5. As discussed previously, the instruction portion 106 and one or more tracking portions 108 can be defined with perforation or scores such that hand separation from the display portion 104 is easily accomplished. Alternatively, separation of the instruction portion 106 and one or more tracking portions 108 from the display portion 104 can be accomplished with a cutting or slicing instrument such as, for example, a knife, a razor blade or a scissors.

Once the magnetic sheet 102 has been separated into separate components, i.e. the display portion 104, the instruction portion 106 and the tracking portions 108, the display portion can be magnetically attached to a suitable surface such as, for example, a kitchen appliance, a bathroom furnishing or the like. As illustrated in FIG. 5, a patient-specific identifier 128 can be positioned within a display window 130 in the display portion 104, wherein the display window 128 is defined by the removal of instruction portion 106 and the one or more tracking portions 108. As illustrated in FIG. 5, patient-specific identifier 128 can comprise a photograph although other suitable identifiers including, for example, a drawing, a word, a nametag, a color, a business card, a bar code or other identifying means could be utilized to correlate the medication tracking system 100 with a specific patient. Preferably, the patient specific identifier 128 has larger dimensions than that of the display window 130 such that placement of the patient specific identifier 128 between the display portion 104 and the mounting surface causes the patient specific identifier 128 to be retainably displayed. In addition to using the patient specific identifier 128 for correlation with a specific patient, a caregiver can write the patient's name 124 on the display portion 104.

Once the display portion 104 has been affixed to the display surface, the instruction portion 106 can be placed in proximity to the display portion such that specific dosing instructions are readily available. Based upon the dispensing instructions contained on instruction portion 106, a caregiver can use tracking portions 108, illustrated as a last dose marker 108a and a next dose marker 108b in FIG. 5 to adjustably track the dispensing of medication 206. For instance, last does maker 108a is magnetically positioned with respect to time scale 116 to indicate when the patient took their most recent dose of medication and next dose marker 108b is magnetically positioned with respect to time scale 116 to indicate when the next dose of medication is scheduled to be taken by the patient. When the next dose of medication is dispensed to the patient, the caregiver removably adjusts the last dose marker 108a and the next dose marker 108b. In this manner, proper dispensation of medication 206 is continually updated for the patient in an easy and convenient manner.

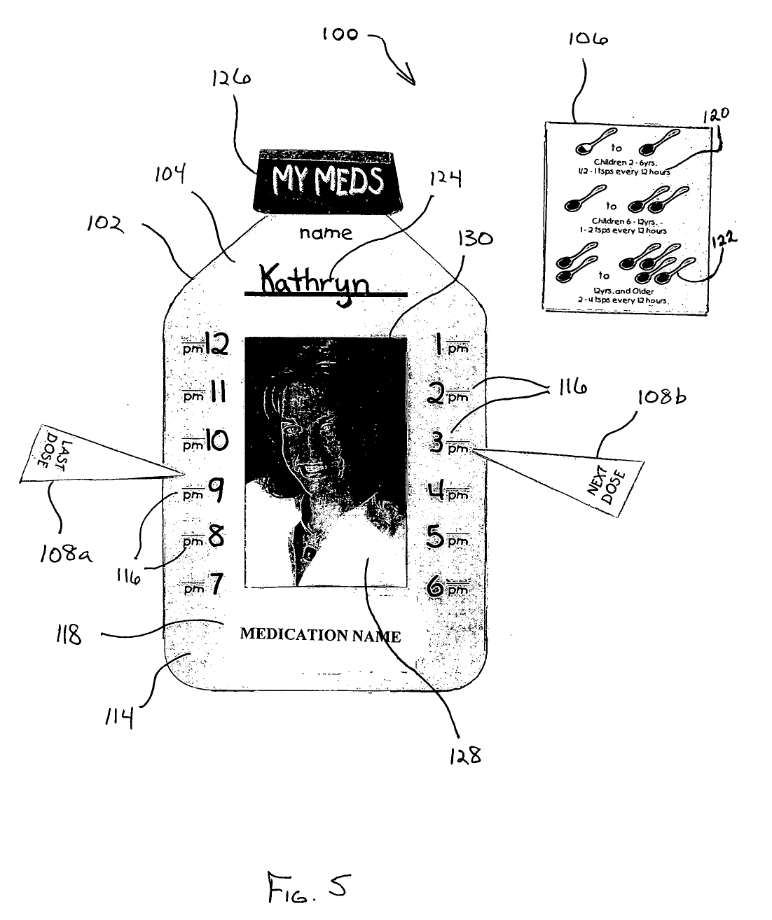

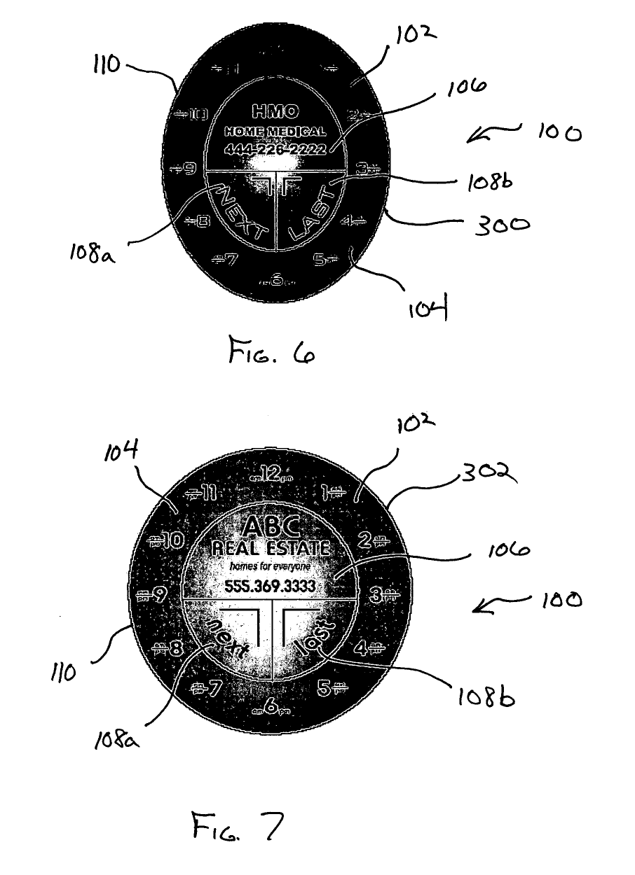

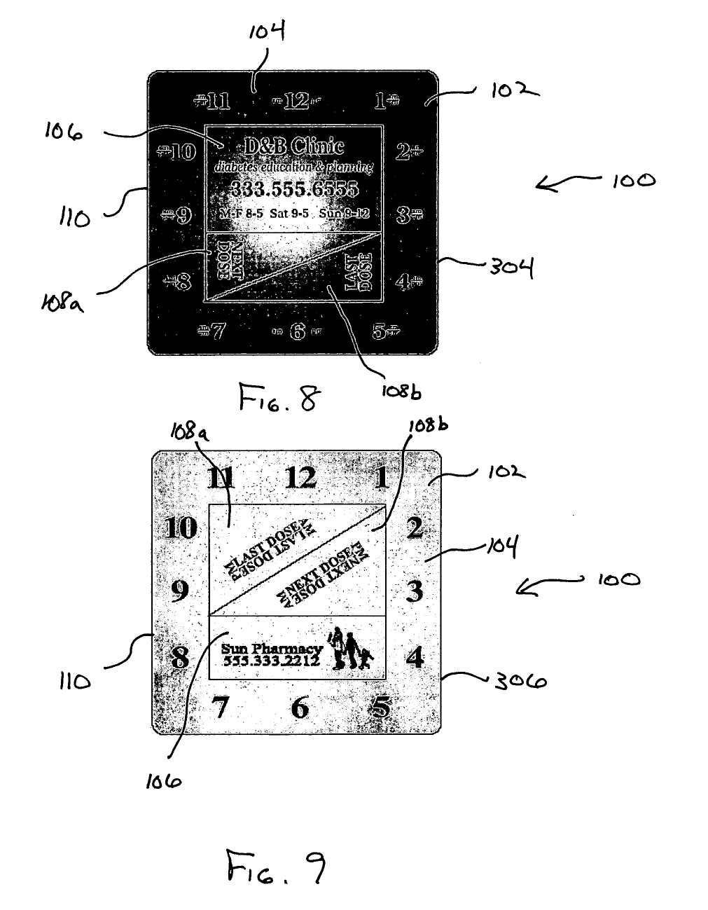

As illustrated in FIGS. 6, 7, 8 and 9, a variety of alternative configurations of medication tracking system 100 are contemplated and can include, for example, an oval configuration 300 as shown in FIG. 6, a circular configuration 302 as shown in FIG. 7, a first square configuration 304 as shown in FIG. 8 and a second square configuration 306 as shown in FIG. 9. Depending upon the supplier of the medication tracking system 100, the instruction portion 106 can include various advertising messages for entities such as, for example, a health clinic, a pharmacy, a health plan or health maintenance organization (HMO), a real estate or insurance company, banks and the like. In addition, medication tracking system 100 can incorporate information pertaining to first responders such as, for example, law enforcement, fire or ambulance contact numbers.

As previously described throughout the application, the medication tracking system 100 is described for use in properly dispensing medication to individuals. In addition to properly tracking medication dispensation, medication tracking system 100 can similarly find application in other settings in which dispensation of items to individuals is necessary. Representative settings for using medication tracking system 100 can include, for example, feeding times for newborns and infants, meal times for adults in hospital, assisted living or nursing home environments, for changing wound dressings in hospital or home settings and for use by diabetics in tracking their blood testing regimen.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

1. A medication tracking and scheduling system comprising:
a display portion having a time scale and a display window, the display window retainably displaying a patient identifier;
an instruction portion including medication dosing instructions; and
a tracking portion having at least one adjustable marker, wherein the at least one adjustable maker is removably positioned with respect to the time scale to visually display a dispensing time relating to the dispensation of medication.

2. The medication tracking and scheduling system of claim 1, wherein the display portion, the instruction portion and the tracking portion are formed from a magnetic sheet to create an integral pre-tracking assembly prior to displaying mediation dispensation information.

3. The medication tracking and scheduling system of claim 2, wherein the instruction portion and the tracking portion are removed from the integral pre-tracking assembly to being displaying medication dispensation information.

4. The medication tracking and scheduling system of claim 1, wherein the tracking portion includes a first adjustable marker and a second adjustable marker, the first adjustable marker positioned with respect to the time scale to indicate a dispensation time for a last dose of medication and the second adjustable marker positioned with respect to the time scale to indicate the dispensation time for a next dose of medication.

5. The medication tracking and scheduling system of claim 1, wherein the display portion includes a calendar display for visually displaying a number of days a patient has received medication.

6. The medication tracking and scheduling system of claim 1, wherein the patient identifier is selected from the group consisting of: a photograph, a drawing, a word, a nametag, a color, a business card and a bar code.

7. The medication tracking and scheduling system of claim 1, wherein the display portion includes a visual feature such that the mediation tracking and scheduling system serves as a promotional tool.

8. The medication tracking and scheduling system of claim 7, wherein the visual feature is selected from the group consisting of: an exterior shape of the display portion, a color of the display portion, a medication name on the display portion, a company name on the display portion and a logo on the display portion.

9. A method for tracking and scheduling medication dispensing comprising:
providing a mediation tracking system having a display portion, an instruction portion and a tracking portion;
positioning the display portion and instruction portion on a visible surface; and
arranging the tracking portion with respect to a time scale on the display portion such that the tracking portion provides a time indication relative to dispensing a medication.

10. The method of claim 9, further comprising:
separating the instruction portion and the tracking portion from the display portion such that a display window is formed in the display portion.

11. The method of claim 10, further comprising:
positioning a patient identifier so as to be seen in the display window.

12. The method of claim 9, wherein positioning the display portion and instruction portion on the visible surface comprises magnetically positioning the display portion and instruction portion on a magnetic, visible surface.

13. The method of claim 12, wherein the magnetic, visible surface is selected from the group consisting of: an appliance surface and a bathroom furnishing surface.

14. The method of claim 12, wherein arranging the tracking portion with respect to the time scale on the display portion includes magnetically positioning the tracking portion with respect to the time scale.

15. The method of claim 9, wherein arranging the tracking portion with respect to the time scale on the display portion includes arranging a first adjustable marker and a second adjustable marker, the first adjustable marker positioned with respect to the time scale to indicate a dispensation time for a last dose of medication and the second adjustable marker positioned with respect to the time scale to indicate the dispensation time for a next dose of medication.

16. The method of claim 9, further comprising:
tracking a number of days that medication with a calendar display on the display portion.

17. The method of claim 9, further comprising:
configuring the display portion so as to have a visual feature corresponding to the medication being dispensed.

18. A medication system comprising:
a medication packaged within a medication container;
and a medication tracking system having a display portion, an instruction portion and a tracking portion, the instruction portion including dosing instructions specific to the medication and wherein the tracking portion is positioned with respect to a time scale on the display portion so as to indicate time-based information relative to dispensing of the medication to a patient.

19. The medication system of claim 18, wherein the medication tracking system is formed from a magnetic sheet such that the display portion and the instruction portion can be attached to a visible magnetic surface and wherein the tracking portion is magnetically positioned with respect to the time scale on the display portion.

20. The medication system of claim 18, wherein the medication container and the medication tracking system are both pre-packaged within a medication package.
